(19) United States
(12) Patent Application Publication
(10) Pub. No.: US 2016/0290457 A1
(43) Pub. Date: Oct. 6, 2016

(54) CVT DRIVE TRAIN

(71) Applicant: SCHAEFFLER TECHNOLOGIES AG & CO. KG, Herzogenaurach (DE)

(72) Inventor: Bernhard WALTER, Oberkirch-Haslach (DE)

(73) Assignee: Schaeffler Technologies AG & Co. KG, Herzogenaurach (DE)

(21) Appl. No.: 15/037,908

(22) PCT Filed: Nov. 28, 2014
(86) PCT No.: PCT/DE2014/200663

§ 371 Date: May 19, 2016

(30) Foreign Application Priority Data
Dec. 9, 2013 (DE) 10 2013 225 227.7

(51) Int. Cl. F16H 37/02

(52) U.S. Cl. CPC F16H 37/022; F16H 2037/023; F16H 2200/0034; F16H 2200/2005

(57) ABSTRACT

A CVT drive train including an input drive, a continuously variable variator, a differential, and a planetary transmission. The drive train achieves at least two operating ranges each with continuously variable transmission ratios. The planetary transmission is a simple planetary gear set with two switching stages.

### CROSS-REFERENCE TO RELATED APPLICATION

This application is the U.S. national phase application under 35 U.S.C. §371 of International Application Serial No. PCT/DE2014/200663, having an international filing date of 28 Nov. 2014, and designating the United States, which claims priority based upon German Patent Application No. DE 10 2013 225 227.7, filed on 9 Dec. 2013, the entire contents of each of which applications are hereby incorporated by reference herein to the same extent as if fully rewritten.

### BACKGROUND OF THE INVENTION

1. Field of the Invention

The present invention relates to a CVT drive train having a drive, a continuously variable variator, a differential and a planetary transmission to achieve at least two operating ranges with continuously variable transmission ratios. In addition, the invention relates to a method for operating such a CVT drive train.

2. Description of the Related Art

The term CVT refers to a stepless transmission; the letters CVT stand for continuously variable transmission. To increase the transmission ratio range of a stepless transmission—its gear ratio spread—it is known from European published application EP 2 275 709 A1 to position a planetary transmission after the stepless transmission. The controllable planetary transmission enables two-range shifting and shifting into reverse. In addition, it is known from German published application DE 102 61 900 A1 to provide a multi-range CVT with fixed engageable gears, for example for moving off or for top speed; however, when these fixed transmission ratios are in operation, the variator is uncoupled. Consequently there is only one stepless range; stepless operation is not possible in all driving ranges.

An object of the present invention is to simplify the construction and/or the operation of a CVT drive train having an input drive, a continuously variable variator, a differential, and a planetary transmission, to achieve at least two operating ranges with continuously variable transmission ratios.

### SUMMARY OF THE INVENTION

The above-stated object is fulfilled in a CVT drive train having an input drive, a continuously variable variator, a differential, and a planetary transmission, to achieve at least two operating ranges with continuous transmission ratios, in that the planetary transmission includes a simple planetary gear set with two switching stages. Engaging and disengaging clutches can be used, for example wet-running clutches of lamellar construction, to achieve the switching stages.

According to an essential aspect of the present invention, the planetary transmission is constructed much more simply than conventional planetary transmissions, which include at least two planetary gear sets. When simplifying the planetary transmission, a loss of operating comfort or shifting comfort is consciously accepted. However, it provides the advantage that the simplified planetary transmission is not only easier to manufacture, but also can be used much more flexibly, for example to achieve a sort of transmission construction set for different classes of torque. Furthermore, construction space can be saved by simplifying the planetary transmission.

A preferred embodiment of the CVT drive train is characterized in that the planetary transmission includes a sun gear, a ring gear, and planet gears which are rotatably supported on a planet carrier. In contrast to conventional planetary transmissions, the planetary transmission in the present invention includes only one sun gear, only one ring gear, and only one planet carrier. Among other things, that provides the advantage that demands can be taken into account more easily and more flexibly when designing the planetary transmission.

Another preferred exemplary embodiment of the CVT drive train is characterized in that the sun gear is connected to a variator output. The sun gear of the planetary transmission is advantageously non-rotatably connected to an output shaft of an output-side conical disk set of the variator.

Another preferred exemplary embodiment of the CVT drive train is characterized in that the planetary transmission is positioned with the simple planetary gear set between the variator and the differential. The variator includes, in addition to the output-side conical disk set, a drive-side conical disk set that is connected in terms of propulsion to the input drive, for example a combustion machine or an internal combustion engine, with the start-up element interposed. The differential serves advantageously on the output side to distribute a torque provided by the input drive, for example, to two driven vehicle wheels.

Another preferred exemplary embodiment of the CVT drive train is characterized in that a rotation reversing device is located downstream of the planetary gear set in the form of a simple planetary gear set, to achieve a reverse gear. The rotation reversing device is intentionally not integrated into the planetary transmission, according to another aspect of the invention. This further simplifies the production of the planetary transmission. Moreover, the intentional separation between the planetary transmission and the rotation reversing device further simplifies achieving the transmission construction set.

Another preferred exemplary embodiment of the CVT drive train is characterized in that the rotation reversing device is implemented as a fixed-stage transmission with a forward branch and a reverse branch. The fixed-stage transmission includes, for example, a spur gear stage and a claw shifter to switch between the forward branch and the reverse branch. Furthermore, the fixed-stage transmission advantageously enables a neutral position or idle position, in which no torque is transmitted via the fixed-stage transmission.

Another preferred exemplary embodiment of the CVT drive train is characterized in that the planetary transmission is designed for a transmission ratio between 2.0 and 4.0 for gearing down. That transmission ratio range has proven to be especially advantageous in investigations carried out within the framework of the present invention.

Another preferred exemplary embodiment of the CVT drive train is characterized in that the variator, the planetary transmission, the rotation reversing device, and the differential are arranged in a front-transverse construction. The terms front and transverse refer to the location where the named components are installed in a motor vehicle. Front means that the input drive, along with the start-up element, the variator, the planetary transmission, and the differential are positioned in a front area or forward area of the motor vehicle. Transverse means that the input drive, together with the above-identified components, is installed transversely in the motor vehicle. In that case, the input drive and the above-identified components, in particular the variator, the planetary transmission, and the rotation reversing device, are arranged side-by-side in the transverse direction of the vehicle.

Another preferred exemplary embodiment of the CVT drive train is characterized in that the planetary transmission with the simple planetary gear set has a smaller outside diameter than an output-side pulley of the variator. That simplifies the installation of the planetary transmission in a motor vehicle that is equipped with the CVT drive train according to the present invention.

In addition, the present invention relates to a method for operating a CVT drive train as described above. The simple planetary gear set of the planetary transmission is used, for example, at a variator ratio of 1.0 in order to switch between the two operating ranges low and high. Either friction clutches or jaw clutches can be used for switching.

In addition, the present invention relates to a start-up element, a variator, a planetary transmission and/or a differential for a CVT drive train as described earlier. Alternatively, or in addition, the present invention also relates to a transmission having the continuously variable variator and the planetary transmission. The transmission can also include a previously-described start-up element and/or a previously-described differential.

### BRIEF DESCRIPTION OF THE DRAWINGS

Additional advantages, features, and details of the invention can be seen from the following description, in which various exemplary embodiments are described in detail with reference to the drawings. The drawing figures show the following:

FIG. 1 is a simplified representation of a CVT drive train according to the present invention in a longitudinal section;

FIG. 2 shows the CVT drive train of FIG. 1 in a cross-sectional view; and

FIG. 3 is a transmission ratio characteristic map of the CVT drive train according to an exemplary embodiment of a method according to the present invention.

### DESCRIPTION OF THE PREFERRED EMBODIMENTS

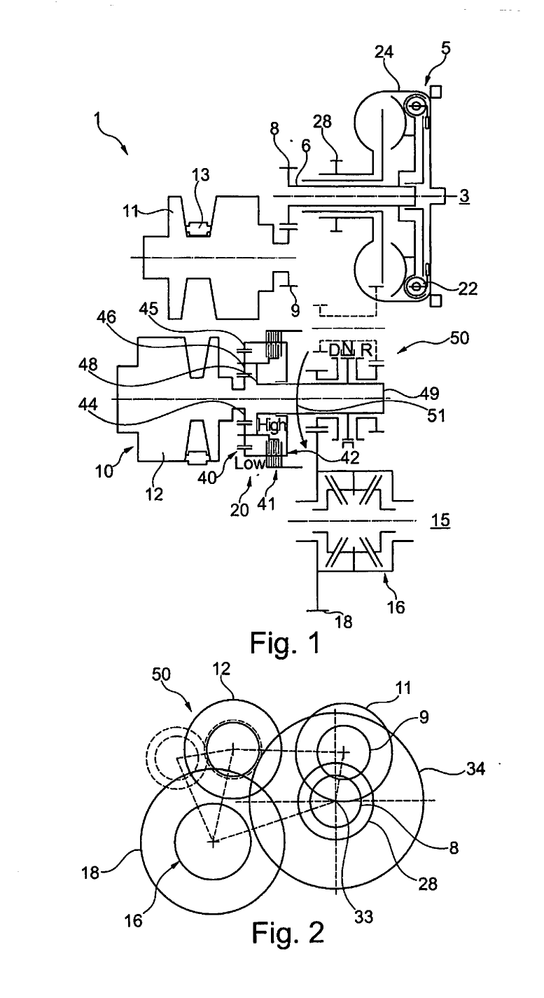

FIGS. 1 and 2 show different views of a simplified representation of a CVT drive train 1 according to the invention. The CVT drive train 1 includes an input drive 3. The input drive is, for example, a combustion machine, which is also referred to as an internal combustion engine when used in a motor vehicle. The CVT drive train 1 is used in motor vehicles.

A start-up element 5 makes it possible to move the motor vehicle off. A torque is forwarded from the drive 3 to a start-up output part 6 through the start-up element 5. The start-up output part 6 is connected to a variator input of a variator 10 through a gear stage having a gear 8 and a gear 9.

The variator 10 includes a conical disk set 11 on the drive side and a conical disk set 12 on the output side. The two conical disk sets 11, 12 are coupled with each other by an endless torque-transmitting means 13, which is only shown generally. The endless torque-transmitting means 13 can be, for example, a special chain.

By means of the two conical disk sets 11 and 12, the transmission ratio between the drive 3 and an output 15 can be varied continuously. The output 15 includes at least one driven wheel (not shown).

Normally, the output 15 is operatively connected to at least two driven vehicle wheels. An equalizing transmission, also referred to as a differential 16, serves to distribute the provided torque to the two driven vehicle wheels. The differential 16 includes a spur gear 18.

A planetary transmission 20 is positioned between the variator 10 and the differential 16. The planetary transmission 20 is operatively connected to a variator output on the output-side conical disk set 12.

A torsional vibration damper 22 is operatively connected to the input drive 3 of the CVT drive train 1. The torsional vibration damper 22 is positioned between the input drive 3 and the start-up element 5. The start-up element 5 is implemented as a torque converter 24. An output part of the torque converter 24 is non-rotatably connected to a gear 28. The gear 28 serves, for example, to drive a pump (not shown). The gear 28 is therefore also referred to as a pump drive gear. However, the gear 28 can also serve to drive a different or an additional vehicle component.

According to another aspect of the present invention, the planetary transmission 20 includes only a simple planetary gear set 40 and two switching stages 41, 42. The simple planetary gear set 40 includes a sun gear 44, which is non-rotatably connected to an output shaft of the output side conical disk set 12 of the variator 10. In addition, the simple planetary gear set includes a ring gear 45. Planet gears 46 are meshed with the ring gear 45 and the sun gear 44. The planet gears 46 are rotatably supported on a planet carrier 48. Planet carrier 48 is non-rotatably connected to a transmission output shaft 49 of the planetary transmission 20.

The two switching stages 41, 42 are implemented as multi-plate clutches, and are positioned between the ring gear 45 and the planet carrier 46. Alternatively, the switching stages 41, 42 can be implemented as jaw clutches. The two switching stages 41 and 42 make it possible to switch between a low range and a high range.

A rotation reversing device 50 is connected downstream of the planetary transmission 20. The rotation reversing device 50 includes a gear stage that is non-rotatably connected to the transmission output shaft 49. By means of a jaw clutch, it is possible to switch between a neutral position N, a forward position D and a reverse position R.

D stands for a forward driving mode, in which a torque supplied by the transmission output shaft 49 is transmitted via a forward branch of the rotation reversing device 50, in a direction indicated by an arrow 51, to the spur gear 18 of the differential 16.

In reverse driving mode R, the torque supplied by the transmission output shaft 49 is transmitted to the spur gear 18 of the differential 16 in the direction of rotation opposite to the direction of rotation when in the forward driving mode.

In the neutral position N, the transmission output shaft 49 is decoupled from the spur gear 18 of the differential 16. Therefore, in the neutral position N no torque is transmitted from the transmission output shaft 49 to the spur gear 18 of the differential 16.

In FIG. 2, an axis of rotation of the crankshaft 33 runs perpendicular to the plane of the drawing. A circle 34 indicates a starter ring gear which is non-rotatably connected to the crankshaft 33. A radially inner circle represents the gear 8 from FIG. 1. Another circle represents the gear 28, also referred to as a pump drive gear. Gear 8 meshes with gear 9, which represents the variator input. Gear 9 is operatively connected to the drive-side conical disk set 11, which is likewise represented in FIG. 2 as a circle. A circle 12 represents the output-side conical disk set.

The circles in FIG. 2 make the front-transverse construction clear. Front-transverse construction means that the input drive 3, in particular the internal combustion engine, and the transmission, here the variator 10, the planetary transmission 20, and the rotation reversing device 50, are positioned next to each other in the transverse direction of the vehicle, for example in front of or above a front axle. The rotation reversing device is positioned to the left of the drive-side pulley 11 and above the differential 16.

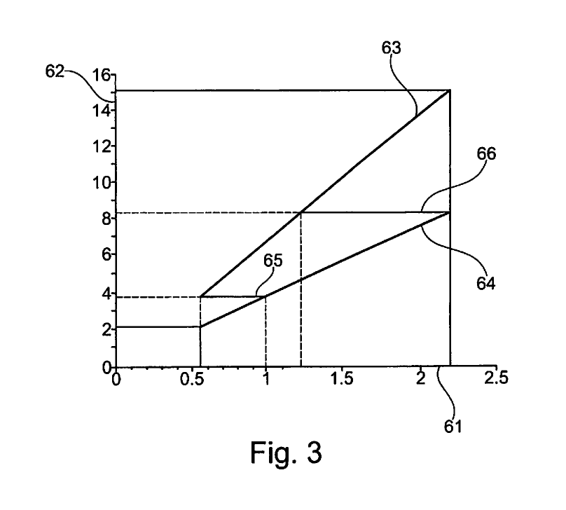

FIG. 3 shows a transmission ratio characteristic map for the CVT drive train shown in FIGS. 1 and 2, in the form of a Cartesian coordinate diagram. The Cartesian coordinate diagram shown in FIG. 3 includes an x-axis 61 and a y-axis 62. A variable ratio of the variator (10 in FIG. 1) is plotted on the x-axis 61. A transmission ratio of the planetary transmission (20 in FIG. 1) is plotted on the y-axis 62.

A characteristic curve 63 represents the low operating range. A characteristic curve 64 represents the high operating range. A line 65 that runs parallel to the x axis 61 indicates a switchover between the low range 63 and the high range 64. The switchover 65 occurs at a variator ratio between about 0.5 and one. In FIG. 3 it can be seen that the switchover 65 occurs at the lower end of the characteristic curve 63 which represents the low range.

Another line 66, which also runs parallel to the x axis 61, shows that the switchover between the low range 63 and the high range 64 can also occur at the upper end of the characteristic curve 64, which represents the high range. The switchover 66 occurs at a variator ratio between about 1.2 and about 2.2.

1. A CVT drive train comprising:
an input drive;
a continuously variable variator;
a differential; and
a planetary transmission to provide at least low and high operating ranges, each operating range having continuous transmission ratios;
wherein the planetary transmission includes a simple planetary gear set with two switching stages for selectively engaging the at least low and high operating ranqes.

2. A CVT drive train according to claim 1, wherein the planetary transmission includes a sun gear, a ring gear, and planet gears that are rotatably supported on a planet carrier.

3. A CVT drive train according to claim 2, wherein the sun gear is connected to a variator output.

4. A CVT drive train according to claim 1, wherein the planetary transmission that includes the simple planetary gear set is positioned between the variator and a differential.

5. A CVT drive train according to claim 1, including a rotation reversing device to achieve a reverse gear (R), wherein the rotation reversing device is connected downstream of the planetary transmission that includes the simple planetary gear set.

6. A CVT drive train according to claim 5, wherein the rotation reversing device is implemented as a fixed-stage transmission having a forward branch (D) and a reverse branch (R).

7. A CVT drive train according to claim 1, wherein the planetary transmission has a transmission ratio of between 2.0 and 4.0 for gearing down.

8. A CVT drive train according to claim 5, wherein the variator, the planetary transmission, the rotation reversing device, and the differential are positioned in a front-transverse arrangement.

9. A CVT drive train according to claim 1, wherein the planetary transmission that includes the simple planetary gear set has a smaller outside diameter than an output-side pulley of the variator.

10. A method for operating the CVT drive train according to claim 1, said method comprising the steps of:
setting a variator ratio of 1.0, and
switching between low and high operating ranges of the simple planetary gear set.
